(19) United States
(12) Patent Application Publication
(10) Pub. No.: US 2026/0189383 A1
(43) Pub. Date: Jul. 2, 2026

(54) OFF-CHIP KEYSTORE SYSTEMS AND METHODS

(71) Applicant: Lattice Semiconductor Corporation, Hillsboro, OR (US)

(72) Inventors: Patrick J. Crotty, San Jose, CA (US); Mehryar Rahmatian, San Jose, CA (US)

(21) Appl. No.: 19/007,159

(22) Filed: Dec. 31, 2024

(51) Int. Cl. H04L 9/08

(52) U.S. Cl. CPC H04L 9/088

(57) ABSTRACT

A system and method for storing keys, secrets, and passwords securely in an off-chip keystore are provided. An off-chip keystore stores a plurality of ciphertext keys that include encrypted keys, secrets, and passwords. A programmable logic device, such as a system on a chip, is coupled to the off-chip keystore. The programable logic device enrolls a physical unclonable function (PUF) within the programmable logic device. The PUF generates a keystore encryption key (KEK) that a secure processor, such as a cryptographic engine, uses to encrypt a plaintext key into a ciphertext key, and decrypt the ciphertext key into the plaintext key. The ciphertext key is stored in the off-chip keystore. When the programmable logic device is powered down, the KEK is not stored within the programmable logic device, but is regenerated to decrypt cyphertext keys and encrypt plaintext keys once the programmable logic device is powered up.

### TECHNICAL FIELD

The disclosure generally relates to secure key storage, and more specifically to a secure key storage off-chip.

### BACKGROUND

Cryptographic keys are fundamental to the security of cryptographic systems. These systems often rely on the secrecy of keys rather than the algorithms themselves. As die sizes continue to shrink, optimizing the use of on-chip die area becomes crucial, especially since the fabrication costs for logic cells at smaller die sizes (7 nm and under) are significantly higher. In small embedded systems like FPGAs and other programmable logic devices, cryptographic keys are typically programmed into the devices themselves during manufacturing using methods such as ROM or Efuse.

Recent security breaches are highlighting the need for higher levels of cryptographic security. One way to reduce the likelihood of the security breaches and increase cryptographic security is to increase the sizes of the security keys (e.g., AES128 to AES256). Additionally, existing cryptographic algorithms are vulnerable to quantum computer attacks. To withstand such attacks, algorithms, such as Post-Quantum Safe Cryptographic algorithms, may use very large key sizes (e.g., over 4,864 bytes). Storing these large keys on small die sizes, e.g., in sub-7 nm on-chip memory, would be prohibitively expensive.

Accordingly, given the shrinking die sizes and increasing cryptographic key sizes, the embodiments are directed to securely storing cryptographic keys off-chip.

### BRIEF DESCRIPTION OF THE DRAWINGS

FIG. 1 illustrates a block diagram of a programmable logic device (PLD) in accordance with some embodiments.

FIG. 2 illustrates another block diagram of a PLD coupled to an off-chip keystore, according to some embodiments.

FIG. 3 is a flowchart of a method for generating a keystore encryption key, according to some embodiments.

FIG. 4 is a flowchart of an exemplary method for encrypting a plaintext key using a keystore encryption key, according to some embodiments.

FIG. 5 is a flowchart of an exemplary method for decrypting a ciphertext key using a keystore encryption key, according to some embodiments.

Embodiments of the present disclosure and their advantages are best understood by referring to the detailed description that follows. It should be appreciated that like reference numerals are used to identify like elements illustrated in one or more of the figures.

### DETAILED DESCRIPTION

The security and secrecy of encryption keys and private secrets (e.g., private keys, secrets, passwords, etc.) are essential for effective cryptography. Compromising these encryption keys and secrets can have serious consequences including loss of sensitive information and reputation.

The embodiments are directed to a security strategy for managing encryption keys within a system-on-chip (SoC) environment. The keystore encryption key (KEK) may be generated within SoC using an unclonable physical function (PUF) key generator. The KEK may be generated each time upon boot-up and is not stored permanently within the SoC.

The other secret keys, secrets, and/or passwords may be encrypted using the KEK and stored in a remote keystore. The remote keystore is off SoC and may be a non-volatile memory, flash memory, and the like. Because the KEK is generated using the PUF each time at SoC boot-up, the KEK does not need to be stored within the SoC. To facilitate secure communication between the SoC and the off-chip memory, a non-secure communication channel may be established between the secure processor (e.g., a cryptographic engine) of the SoC and the off-chip memory. The traffic and data stored in the off-chip memory may be encrypted to ensure security and decrypted at the SoC using KEK.

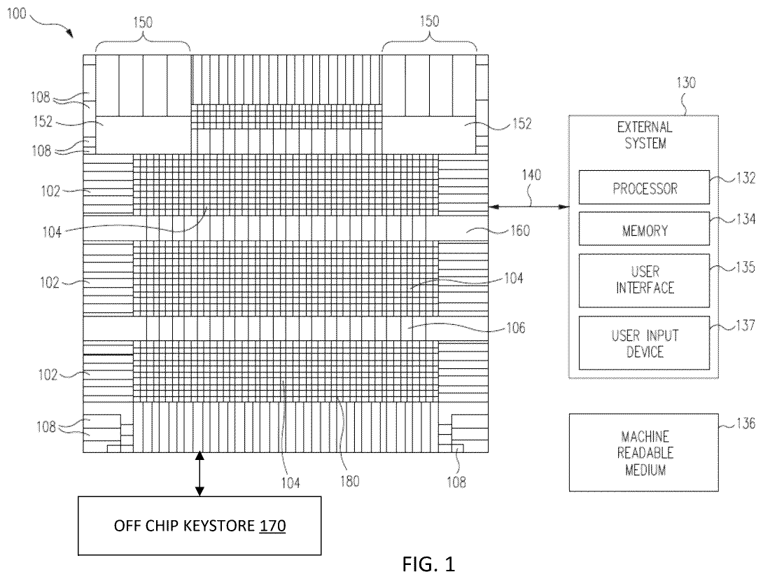

FIG. 1 illustrates a block diagram of a programmable logic device (PLD) 100 in accordance with an embodiment of the disclosure. PLD 100 (e.g., a field programmable gate array (FPGA)), a complex programmable logic device (CPLD), a field programmable system on a chip (FPSC), or other type of programmable device) generally includes input/output (I/O) blocks 102 and logic blocks 104 (e.g., also referred to as programmable logic blocks (PLBs), programmable functional units (PFUs), or programmable logic cells (PLCs)).

I/O blocks 102 provide I/O functionality (e.g., to support one or more I/O and/or memory interface standards) for PLD 100, while programmable logic blocks 104 provide logic functionality (e.g., LUT-based logic or logic gate array-based logic) for PLD 100. Additional I/O functionality may be provided by serializer/deserializer (SerDes) blocks 150 and physical coding sublayer (PCS) blocks 152. PLD 100 may also include hard intellectual property core (IP) blocks 160 to provide additional functionality (e.g., substantially predetermined functionality provided in hardware which may be configured with less programming than logic blocks 104).

PLD 100 may also include blocks of memory 106 (e.g., blocks of EEPROM, block SRAM, and/or flash memory), clock-related circuitry 108 (e.g., clock sources, PLL circuits, and/or DLL circuits), and/or various routing resources 180 (e.g., interconnect and appropriate switching logic to provide paths for routing signals throughout PLD 100, such as for clock signals, data signals, or others) as appropriate. In general, the various elements of PLD 100 may be used to perform their intended functions for desired applications, as would be understood by one skilled in the art.

For example, certain I/O blocks 102 may be used for programming memory 106 or transferring information (e.g., various types of user data and/or control signals) to/from PLD 100. Other I/O blocks 102 include a first programming port (which may represent a central processing unit (CPU) port, a peripheral data port, an SPI interface, and/or a sysCONFIG programming port) and/or a second programming port such as a joint test action group (JTAG) port (e.g., by employing standards such as Institute of Electrical and Electronics Engineers (IEEE) 1149.1 or 1532 standards). In various embodiments, I/O blocks 102 may be included to receive configuration data and commands (e.g., over one or more connections 140) to configure PLD 100 for its intended use and to support serial or parallel device configuration and information transfer with SerDes blocks 150, PCS blocks 152, hard IP blocks 160, and/or logic blocks 104 as appropriate.

It should be understood that the number and placement of the various elements are not limiting and may depend upon the desired application. For example, various elements may not be required for a desired application or design specification (e.g., for the type of programmable device selected).

Furthermore, it should be understood that the elements are illustrated in block form for clarity and that various elements would typically be distributed throughout PLD 100, such as in and between logic blocks 104, hard IP blocks 160, and routing resources 180 to perform their conventional functions (e.g., storing configuration data that configures PLD 100 or providing interconnect structure within PLD 100). It should also be understood that the various embodiments disclosed herein are not limited to programmable logic devices, such as PLD 100, and may be applied to various other types of programmable devices, as would be understood by one skilled in the art.

An external system 130 may be used to create a desired user configuration or design of PLD 100 and generate corresponding configuration data to program (e.g., configure) PLD 100. For example, system 130 may provide such configuration data to one or more I/O blocks 102, SerDes blocks 150, and/or other portions of PLD 100. As a result, programmable logic blocks 104, various routing resources, and any other appropriate components of PLD 100 may be configured to operate in accordance with user-specified applications.

In the illustrated embodiment, system 130 is implemented as a computer system. In this regard, system 130 includes, for example, one or more processors 132 which may be configured to execute instructions, such as software instructions, provided in one or more memories 134 and/or stored in non-transitory form in one or more non-transitory machine-readable mediums 136 (e.g., which may be internal or external to system 130). For example, in some embodiments, system 130 may run PLD configuration software, such as Lattice Diamond System Planner software available from Lattice Semiconductor Corporation to permit a user to create a desired configuration and generate corresponding configuration data to program PLD 100.

System 130 also includes, for example, a user interface 135 (e.g., a screen or display) to display information to a user, and one or more user input devices 137 (e.g., a keyboard, mouse, trackball, touchscreen, and/or other device) to receive user commands or design entry to prepare a desired configuration of PLD 100.

In some embodiments, PLD 100 may be coupled to an off-chip keystore 170. Off-chip keystore 170 may be a memory storage, such as non-volatile memory, flash memory, and the like. Off-chip keystore 170 may store encrypted passwords, secrets, keys, and other types of ciphertext that may be used by PLD 100 during execution, boot-up, and the like. Off-chip keystore 170 may be within the same package as PLD 100. Although shown separately from system 130, off-chip keystore 170 may also be included within system 130.

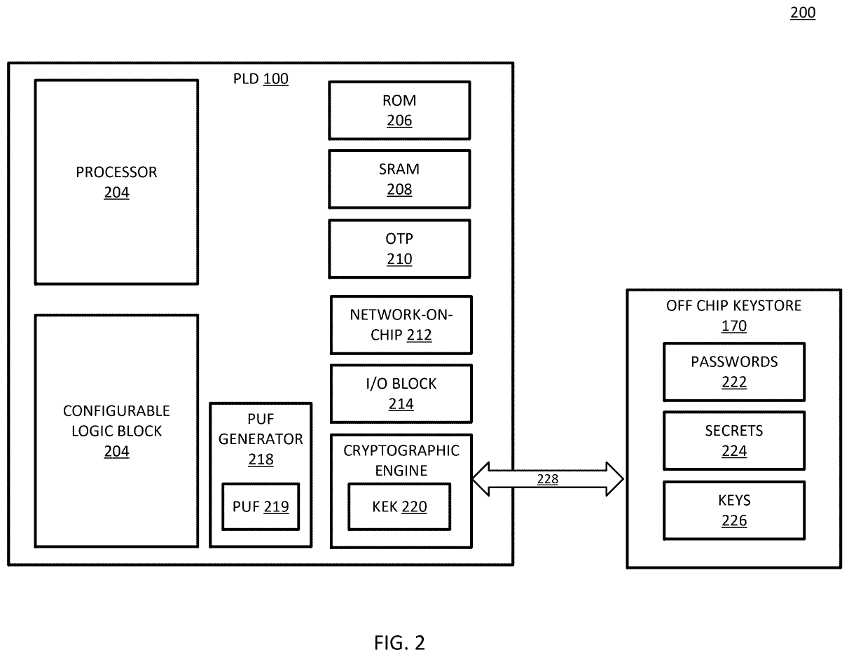

FIG. 2 is a diagram 200 illustrates another diagram of a PLD 100, according to an embodiment. PLD 100 in FIG. 2 may include components in addition to those discussed in FIG. 1. As discussed in FIG. 1, PLD 100 may be a system-on-chip (SoC). As illustrated in FIG. 2, PLD 100 may include a processor 202, a configurable logic block 204, a Read-Only Memory (ROM) 206, a Static Random-Access Memory (SRAM) 208, a One-Time Programmable (OTP) memory 210, a Network-on-Chip (NoC) 212, and an input/output block 214. Processor 202 may be configured to execute instructions, such as software instructions, provided from one or more of configurable logic block 204, ROM 206, SRAM 208, OTP memory 210 or one or more other memories that may be internal or external to PLD 100.

Configurable logic block 204 may be one of programmable logic blocks 104 that may be configured to provide logic functionality (e.g., LUT-based logic or logic gate array-based logic) for PLD 100.

ROM 206 may be a non-volatile memory that is used to store firmware or software that is not intended to be modified during PLD 100's operation. ROM 206 retains data when the power is turned off, making it useful for storing critical boot and system initialization code and other essential programs that should be readily available upon powering up of PLD 100. ROM 206 plays a role in ensuring that PLD 100 may reliably start up and function correctly. The data stored in ROM 206 is typically written during the manufacturing process and is not meant to be altered, providing a stable and secure foundation for the PLD 100's operation.

SRAM 208 may be a volatile memory that provides high-speed data storage and retrieval. SRAM 208 uses bistable latching circuitry to retain data as long as power is supplied to PLD 100. SRAM 208 may be integrated to store frequently accessed data and instructions, which may enhance overall performance and efficiency of the PLD 100.

OTP memory 210 may be a non-volatile memory that may be written to once and read many times. OTP memory 210 may typically be used for storing firmware, configuration settings, and other critical data that may not be altered after initial programming. OTP memory 210 is advantageous in PLD applications due to its reliability, security, and cost-effectiveness. Once data is written to OTP memory 210, the data becomes permanently fixed, making it highly resistant to tampering and ideal for applications requiring secure and immutable storage. This characteristic ensures that the programmed data remains intact even in the event of a power loss, providing a robust solution for embedded systems and other applications where data integrity and security are paramount.

NoC 212 is an advanced communication subsystem within PLD 100 that facilitates efficient data transfer between various components, such as processor 202, memories 206, 208, 210, and peripheral interfaces. NoC 212 employs a network-based approach, using routers and links to create a scalable and high-performance communication infrastructure. Some benefits of NoC 212 may include reduced latency and improved system throughput.

I/O block 214 may be one of I/O blocks 102 that provide I/O functionality to PLD 100.

In some instances, PLD 100 may also include a cryptographic engine 216 and a physical unclonable function (PUF) generator 218. Cryptographic engine 216 may be a dedicated hardware processor or module designed to perform cryptographic operations within PLD 100. Cryptographic engine 216 is a specialized and secure component that handles encryption, decryption, authentication, hashing, and digital signature generation and/or verification. For example, cryptographic engine 216 may generate plaintext keys, such as passwords 222, secrets 224, and keys 226 that perform encryption, decryption, hashing, verification, and/or authentication functions within PLD 100. Cryptographic engine 216 may generate the plaintext keys on demand. By offloading these computationally intensive operations from processor 202, cryptographic engine 216 may enhance the overall performance and security of PLD 100. Cryptographic engine 216 may ensure that sensitive data is processed in a secure environment, which also reduces the risk of exposure to potential vulnerabilities. Cryptographic engine 216 may support various cryptographic algorithms and standards, which enable cryptographic engine 216 to service different security applications in various areas including secure communications, data protection, and authentication.

PUF generator 218 is a security feature integrated into PLD 100 that may generate PUF 219. PUF 219 leverages the inherent physical variations in each PLD 100 due to semiconductor manufacturing to generate unique identifiers or cryptographic keys. These variations in PLD 100 are unpredictable and cannot be replicated, even by the same manufacturing process. As such, each PUF 219 is unique to its corresponding PLD 100. PUF 219 may be used to enhance security by providing a hardware-based root of trust, which can be employed for secure key storage, key authentication, device authentication, and anti-counterfeiting measures. The uniqueness and unpredictability of PUF 219 may make PUF 219 resistant to cloning and tampering, thereby offering a robust security mechanism for PLD 100. In some instances, PUF 219 may generate a keystore encryption key (KEK) 220. Because PUF 219 is generated based on intrinsic properties and physical variations in PLD 100, each KEK 220 is unique to each PLD 100.

Cryptographic engine 216 may receive KEK 220 and use KEK 220 to perform cryptographic functions on plaintext keys. For example, cryptographic engine 216 may use KEK 220 to encrypt passwords 222, secrets 224, and keys 226 into ciphertext keys. Notably, KEK 220 may be stored within cryptographic engine 216 when PLD 100 has power. When PLD 100 powers down, KEK 220 is not stored within PLD 100. Instead, KEK 220 is regenerated using PUF 219 once the PLD 100 powers up.

Cryptographic engine 216 may also be coupled, via a hardware link 228, to an off-chip keystore 170. Off-chip keystore 170 may be a secure, non-volatile memory storage that stores the encrypted ciphertext keys that include KEK-encrypted passwords 222, secrets 224, and keys 226. Once cryptographic engine 216 uses KEK 220 to encrypt passwords 222, secrets 224, and keys 226 into ciphertext keys, cryptographic engine 216 may store the encrypted passwords 222, secrets 224, and keys 226 in off-chip keystore 170.

PLD 100 may use one or more of passwords 222, secrets 224, and keys 226 as plaintext keys for decryption, hashing, verification, authentication, etc. This may occur at boot-up, which may involve decrypting a bitstream, or upon receiving a request, e.g., a user command to perform a cryptographic function. In this case, cryptographic engine 216 may request the corresponding ciphertext key, e.g., one or more of the KEK-encrypted passwords 222, secrets 224, and keys 226 from off-chip keystore 170. Upon receipt, cryptographic engine 216 may decrypt the received ciphertext key into the plaintext key, and use the plaintext key to perform decryption, hashing, verification, and/or authentication functions. Notably, KEK 220 itself need not be permanently stored within PLD 100, e.g., in ROM 206, SRAM 208, and/or OTP memory 210 because it can be recreated using PUF generator 218 and PUF 219 as needed.

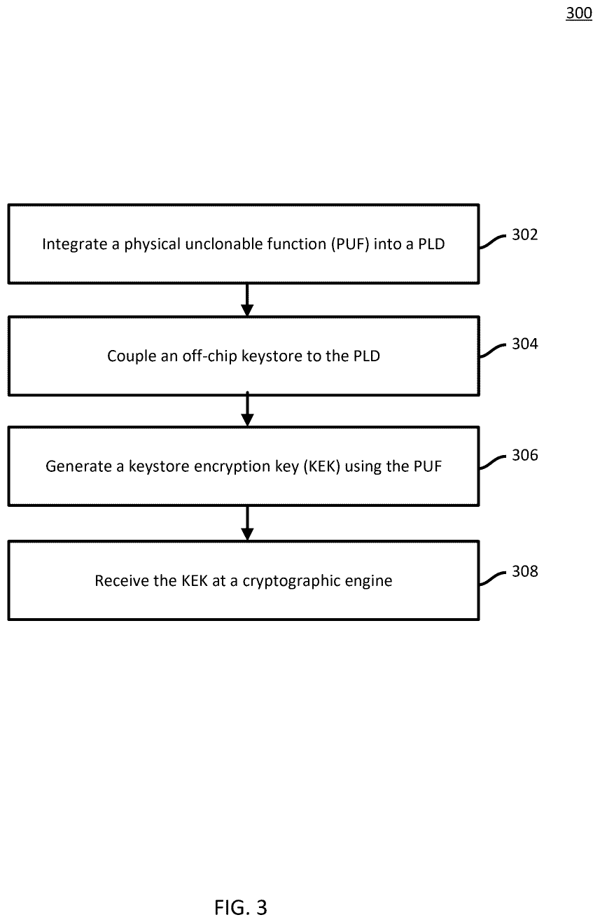

FIG. 3 is a flowchart of an exemplary method 300 for generating a keystore encryption key, according to some embodiments. Notably, method 300 is exemplary and other methods may also be used. The operations 302-308 in method 300 may be implemented using the hardware circuitry discussed in FIGS. 1-2. Note that one or more of the operations may be deleted, combined, or performed in a different order as appropriate.

At operation 302, a PUF is integrated with a PLD. For example, PUF generator 218 that includes PUF 219 is enrolled with PLD 100 when PLD 100 is manufactured.

At operation 304, off-chip keystore is coupled to the PLD. For example, off-chip keystore 170 is coupled to PLD 100. Typically, off-chip keystore 170 is coupled to PLD 100 using a hardware link 228. Further, PLD 100 and off-chip keystore 170 may be within the same package.

At operation 306, a KEK is generated. For example, PUF 219 may generate KEK 220 based on the intrinsic properties of the circuits within PLD 100. KEK 220 is not stored within PLD 100 once PLD 100 is powered down.

At operation 308, a KEK is received at a cryptographic engine. For example, cryptographic engine 216 may receive KEK 220 generated using PUF 219. Cryptographic engine 216 may use KEK 220 to perform cryptographic functions, such as encrypting plaintext keys (e.g., passwords 222, secrets 224, and/or keys 226) into ciphertext keys, or decrypting the ciphertext keys into plaintext keys.

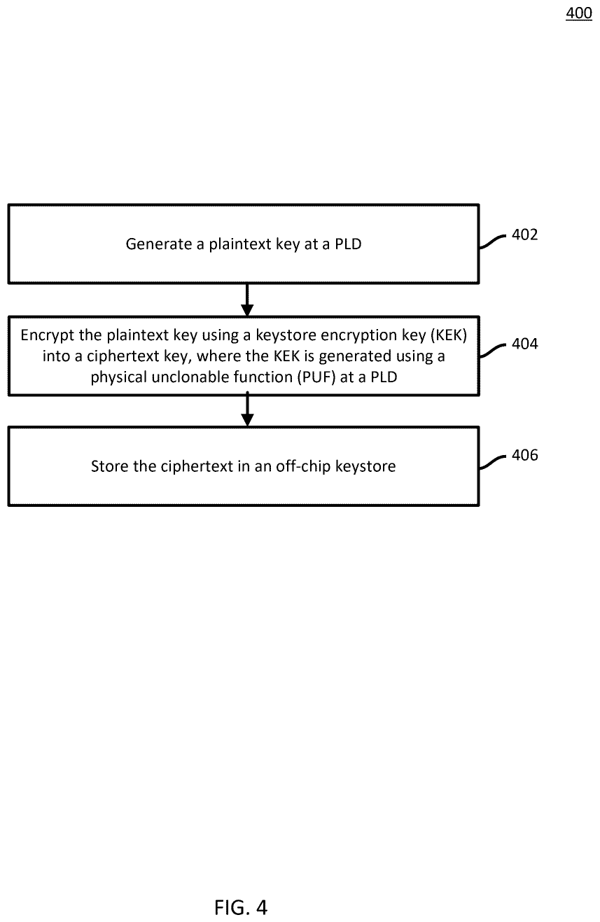

FIG. 4 is a flowchart of an exemplary method 400 for encrypting a plaintext key using a keystore encryption key, according to some embodiments. Notably, method 400 is exemplary and other methods may also be used. The operations 402-406 in method 400 may be implemented using the hardware circuitry discussed in FIGS. 1-2. Note that one or more of the operations may be deleted, combined, or performed in a different order as appropriate.

At operation 402, a plaintext key is generated. For example, during a cryptographic operation, cryptographic engine 216 may generate a plaintext key, which may be one of passwords 222, secrets 224 and/or keys 226.

At operation 404, the plaintext key is encrypted using the KEK. For example, cryptographic engine 216 may encrypt the plaintext key (e.g., one of passwords 222, secrets 224 and/or keys 226) using KEK 220 into ciphertext key. In some instances, when KEK 220 does not exist within cryptographic engine 216, cryptographic engine 216 may request PUF generator 218 and PUF 219 to generate or regenerate KEK 220 as discussed in operation 306 (not shown). This may occur when PLD 100 is powered down because KEK 220 is not stored within PLD 100.

At operation 406, the ciphertext key is transmitted to off-chip storage. For example, PLD 100 may transmit the ciphertext key over hardware link 228 to off-chip keystore 170 for storage as one of encrypted passwords 222, secrets 224 and/or keys 226. Off-chip keystore 170 ensures that the encrypted passwords 222, secrets 224 and/or keys 226 are securely stored for future use by PLD 100.

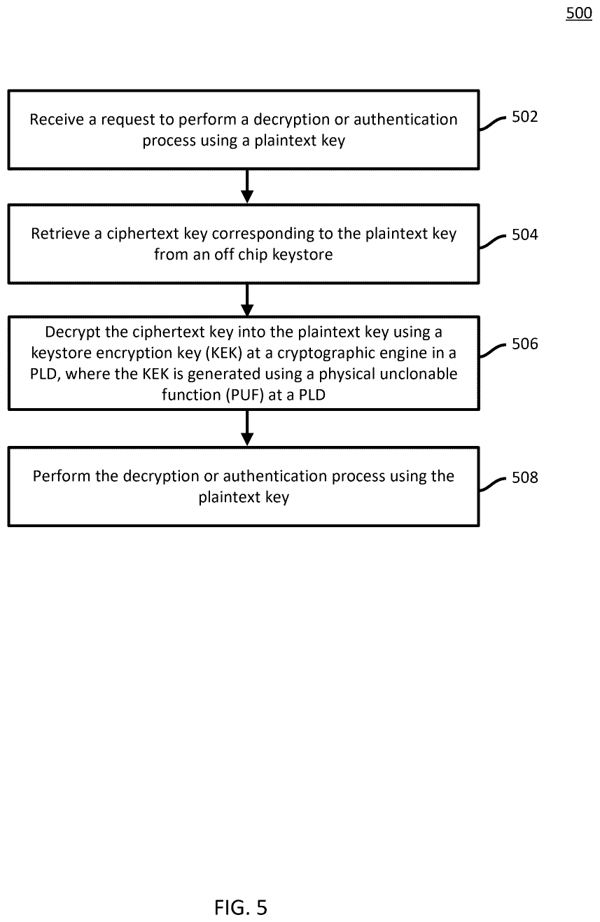

FIG. 5 is a flowchart of an exemplary method 500 for decrypting a ciphertext key using a keystore encryption key, according to some embodiments. Notably, method 500 is exemplary and other methods may also be used. The operations 502-508 in method 500 may be implemented using the hardware circuitry discussed in FIGS. 1-2. Note that one or more of the operations may be deleted, combined, or performed in a different order as appropriate.

At operation 502, a request is received to perform a decryption, hash, verification, or authentication process using a plaintext key. For example, PLD 100 receives a request, which may be a user command or a request during a PLD boot-up process for a cryptographic operation using a plaintext key. The plaintext key may be used to perform a decryption process (e.g., bitstream decryption), verification, hash, or authentication process.

At operation 504, a ciphertext key corresponding to the plaintext key is retrieved from the off-chip keystore. For example, when a cryptographic function (e.g., bitstream decryption, authentication) uses the plaintext key, cryptographic engine 216 may retrieve the corresponding ciphertext key that includes the encrypted plaintext key (e.g., one or more of passwords 222, secrets 224, and/or keys 226) from the off-chip keystore 179 over a hardware link 228.

At operation 506, the ciphertext key is decrypted using a KEK. For example, cryptographic engine 216 may decrypt the received ciphertext key that includes an encrypted one or more of passwords 222, secrets 224 and/or keys 226 using KEK 220 into a corresponding plaintext key. In some instances, when KEK 220 does not exist within cryptographic engine 216, cryptographic engine 216 may request PUF generator 218 and PUF 219 to generate or regenerate KEK 220 as discussed in operation 306 (not shown). This may occur when PLD 100 is powered down because KEK 220 is not stored within PLD 100.

At operation 508, a cryptographic function is performed. For example, cryptographic engine 216 may use the plaintext key, which may be one or more of passwords 222, secrets 224, and/or keys 226, to perform a cryptographic function, such as a decryption or authentication process within the PLD 100.

Where applicable, various embodiments provided by the present disclosure can be implemented using hardware, software, or combinations of hardware and software. Also, where applicable, the various hardware components and/or software components set forth herein can be combined into composite components comprising software, hardware, and/or both without departing from the spirit of the present disclosure. Where applicable, the various hardware components and/or software components set forth herein can be separated into sub-components comprising software, hardware, or both without departing from the spirit of the present disclosure. In addition, where applicable, it is contemplated that software components can be implemented as hardware components, and vice versa.

Software in accordance with the present disclosure, such as program code and/or data, can be stored on one or more non-transitory machine-readable mediums. It is also contemplated that software identified herein can be implemented using one or more general purpose or specific purpose computers and/or computer systems, networked and/or otherwise. Where applicable, the ordering of various steps described herein can be changed, combined into composite steps, and/or separated into sub-steps to provide features described herein.

Embodiments described above illustrate but do not limit the invention. It should also be understood that numerous modifications and variations are possible in accordance with the principles of the present invention. Accordingly, the scope of the invention is defined only by the following claims.

We claim:

1. A system comprising:
an off-chip keystore configured to store a plurality of ciphertext keys; and
a programmable logic device coupled to the off-chip keystore, the programable logic device configured to:
enroll a physical unclonable function (PUF) within the programmable logic device;
generate a keystore encryption key (KEK) using the PUF, wherein the KEK is configured to encrypt a plaintext key into a ciphertext key within the programmable logic device; and
store the ciphertext key at the off-chip keystore as one of the plurality of ciphertext keys.

2. The system of claim 1, further comprising:
a cryptographic engine within the programmable logic device, the cryptographic engine configured to:
receive the KEK generated using the PUF;
generate the plaintext key; and
encrypt the plaintext key into the ciphertext key using the KEK.

3. The system of claim 2, wherein the cryptographic engine is further configured to:
receive a request that the plaintext key is to be used in a decryption process or an authentication process;
retrieve the ciphertext key from the off-chip keystore;
decrypt the ciphertext key into the plaintext key using the KEK; and
perform the decryption process or the authentication process using the plaintext key.

4. The system of claim 3, wherein the programmable logic device is further configured to:
determine that the KEK is not present at the programmable logic device; and
regenerate the KEK using the PUF.

5. The system of claim 4, wherein the decryption process or the authentication process is to occur during a boot of the programmable logic device.

6. The system of claim 1, wherein the KEK is not stored within the programmable logic device when the programmable logic device powers down.

7. The system of claim 6, wherein the programmable logic device is further configured to regenerate the KEK using the PUF after the programmable logic device is powered up.

8. The system of claim 1, wherein the off-chip keystore and the programmable logic device are within a same package.

9. A system comprising:
an off-chip keystore configured to securely store a plurality of ciphertext keys; and
a programmable logic device coupled to the off-chip keystore and the programmable logic device configured to:
enroll a physical unclonable function (PUF) in the programmable logic device; and
generate a keystore encryption key (KEK) using the PUF, wherein the KEK is configured to decrypt a ciphertext key stored in the off-chip keystore as one of the plurality of ciphertext keys into a plaintext key.

10. The system of claim 9, further comprising:
a cryptographic engine within the programmable logic device, and the cryptographic engine configured to:
receive a request that the plaintext key is to be used in a decryption process or an authentication process;
retrieve the ciphertext key corresponding to the plaintext key from the off-chip keystore;
decrypt the ciphertext key into the plaintext key using the KEK; and
perform the decryption process or the authentication process using the plaintext key.

11. The system of claim 10, wherein the programmable logic device is further configured to:
determine that the KEK is not present at the programmable logic device; and
regenerate the KEK using the PUF.

12. The system of claim 11, wherein the decryption process or the authentication process is to occur during a boot-up of the programmable logic device.

13. The system of claim 9, further comprising:
a cryptographic engine within the programmable logic device, and the cryptographic engine configured to:
generate the plaintext key to perform a decryption process or an authentication process;
encrypt the plaintext key into the ciphertext key using the KEK generated using the PUF; and
transmit the ciphertext key to the off-chip memory for storage as one of the plurality of ciphertext keys.

14. The system of claim 9, wherein the KEK is not stored within the programmable logic device after the programming logic device is powered down.

15. The system of claim 14, wherein the programmable logic device is further configured to:
regenerate the KEK using the PUF of the programmable logic device after the programmable logic device is powered back up.

16. The system of claim 9, wherein the off-chip keystore and the programmable logic device are within a same package.

17. A method comprising:
enrolling a physical unclonable function (PUF) at a programmable logic device; and
generating a keystore encryption key (KEK) using the PUF, wherein the KEK is configured to encrypt a plaintext key into a ciphertext key or decrypt the ciphertext key into the plaintext key, wherein the ciphertext key is stored in an off-chip keystore coupled to the programmable logic device.

18. The method of claim 17, further comprising:
receiving, during boot-up of the programming logic device, a request that the plaintext key is to be used in a decryption process or an authentication process;
retrieving the ciphertext key from the off-chip keystore;
decrypting, at a cryptographic engine, the ciphertext key into the plaintext key using the KEK; and
performing the decryption process or the authentication process using the plaintext key.

19. The method of claim 17, further comprising:
generating, at a cryptographic device within the programming logic device, the plaintext key configured to perform a decryption process or an authentication process;
encrypting the plaintext key into the ciphertext key using the KEK generated using the PUF; and
storing the ciphertext key to the off-chip memory as one of a plurality of ciphertext keys.

20. The method of claim 17, wherein the KEK is not stored within the programmable logic device after the programming logic device is powered down, and further comprising:
regenerating the KEK using the PUF of the programmable logic device after the programmable logic device is powered back up.
